(19) United States
(12) Patent Application Publication
(10) Pub. No.: US 2006/0090709 A1
(43) Pub. Date: May 4, 2006

(54) Destructible Dog Toy

(76) Inventor: Peter Joseph Lopus, Orchard Park, NY (US)

Correspondence Address: PETER J. LOPUS, 16 GREENWOOD DR, ORCHARD PARK, NY, 14127, US

(21) Appl. No.: 10/904,195

(22) Filed: Oct. 28, 2004

(51) Int. Cl. A01K 29/00

(52) U.S. Cl. 119/709

(57) ABSTRACT

A method of enriching an animal comprised of an inner core of fibrous material enclosed in an outer shell of burlap. The preferred configuration of the devise being the burlap sewn together forming closed compartments in order to hold the fibrous material, the burlap shell and fibrous core being readily torn, separated and scattered. A user allows an animal to bite, shake and rip apart the device for training and in order appease its innate urges and provide enrichment.

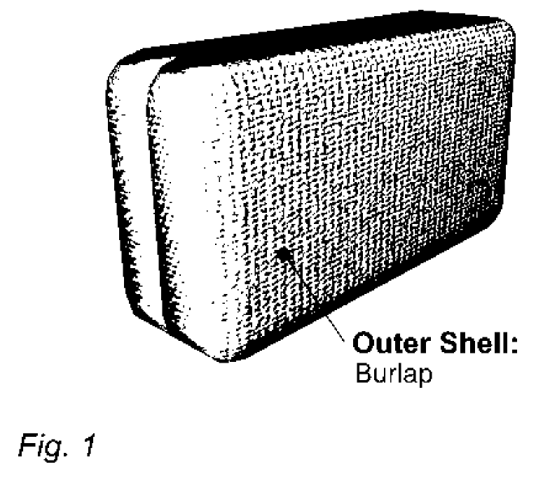

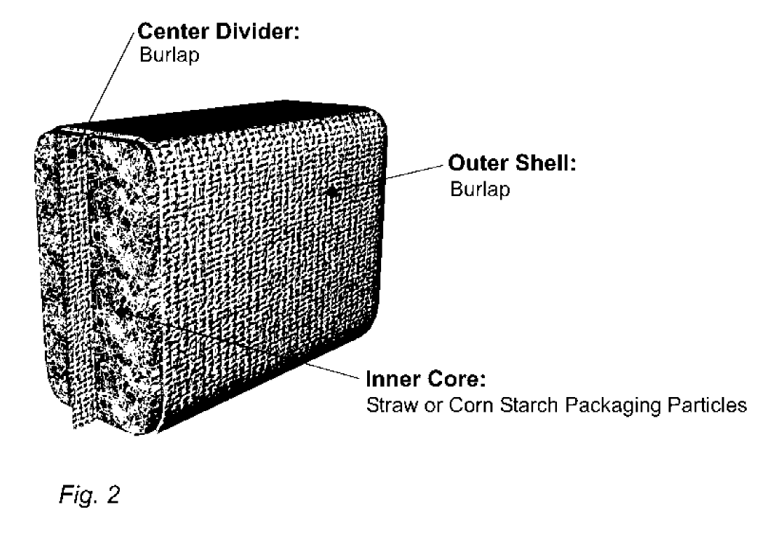

### A BRIEF SUMMARY OF THE INVENTION

My invention is a method of enriching a domestic animal, such as a dog, by means of a toy that is made to be torn apart and destroyed by biting, shaking and ripping. The toy can be used by the dog and owner together as a training device that, utilizing positive reinforcement, teaches the animal to chew, shake or rip the right thing. Also, it is intended that the toy can be given to the dog when the dog is left alone in its confines, thus providing an alternative to destruction of other property or to digging. The toy is intended for one-time usage after which it is replaced with a new one.

### BACKGROUND OF INVENTION

Today, a pet dog's innate urges to chew, shake and rip apart remain suppressed due to centuries of domestication. The vast majority of existing dog toys, designed to help satisfy these urges, are one-dimensional, only addressing the urge to chew. Furthermore existing toys fail to satisfy the urge to rip apart by failing to be readily destroyed. Existing systems are either a) configured, or b) made of materials, that are intended to make them durable and in effect, difficult to rip apart. This diminishes their effectiveness.

### PRIOR ART

U.S. Pat. No. 5,215,038 addresses the urge for dogs to chew, however it is not designed to be readily ripped apart, say in one sitting. The predominance of its configuration is designed to be pliable in order to retain it's shape and prevent it from coming apart. It is designed for durability and repeat usage.

U.S. Pat. No. 6,623,328 addresses the urge to rip apart utilizing a dismemberable configuration; however it is comprised of sub-sections designed not to be destroyed. They are designed to be durable for repeat usage.

The objective of durability for repeat usage being central to their design; these inventions are limited in their effectiveness in appeasing canine urges. They do not provide canine enrichment.

### OBJECT OF INVENTION

The object of my invention is to provide an enrichment activity for domestic canines giving them the opportunity to completely destroy by chewing, shaking and ripping apart an object, therefore more fully satisfying their innate urges. The invention is designed to be completed destroyed during its initial use. Furthermore the materials that make up my invention are designed to be appealing to the dog's sense of smell and touch. Also, they are to provide enough strength so that the activity will be a challenge. These materials will not be harmful to the animal or the environment.

What is claimed is:

1. A toy for an animal, such as a dog, comprised of an inner core of fibrous material enclosed in an outer shell of burlap. The burlap shell and fibrous core being readily torn, separated and scattered when chewed, shaken and ripped by the animal.

2. The device in claim 1 where said fibrous material is straw.

3. The device in claim 1 where said fibrous material is corn-starch packaging particles.
